(19) United States
(12) Patent Application Publication
(10) Pub. No.: US 2026/0194799 A1
(43) Pub. Date: Jul. 9, 2026

(54) ILLUMINATION SYSTEM AND PROJECTION APPARATUS

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 19/412,757

(22) Filed: Dec. 8, 2025

(30) Foreign Application Priority Data
Jan. 9, 2025 (CN) 202510032412.1

(51) Int. Cl. G03B 21/20

(52) U.S. Cl. CPC G03B 21/2066; G03B 21/2013; G03B 21/204; G03B 21/208

(57) ABSTRACT

An illumination system including a plurality of light sources, a first dichroic mirror, a second dichroic mirror, a first reflecting mirror and a second reflecting mirror is provided. The first light source and the third light source are arranged along a first direction, and each emits color lights along a second direction. The second light source and the fourth light source are staggered along the first direction, and each emits color lights along a third direction. The first dichroic mirror and the first reflecting mirror are disposed corresponding to the first light source and the second light source. The second dichroic mirror and the second reflecting mirror are disposed corresponding to the third light source and the fourth light source. The first reflecting mirror and the second reflecting mirror are staggered along the first direction, and each has the same height along the third direction.

### CROSS-REFERENCE TO RELATED APPLICATION

This application claims the priority benefit of China application serial no. 202510032412.1, filed on January 9, 2025. The entirety of the above-mentioned patent application is hereby incorporated by reference herein and made a part of this specification.

### BACKGROUND

### Technical Field

The disclosure relates to an optical system and an optical apparatus, and particularly relates to an illumination system and a projection apparatus applying the illumination system.

### Description of Related Art

A projection apparatus is a display apparatus used for generating large-area images, and continues to advance with technological development and innovation. The imaging principle of the projection apparatus is to convert an illumination light beam generated by an illumination system into an image light beam via a light valve, and then project the image light beam through a projection lens onto a projection target (e.g., a screen or wall) to form a projected image. To achieve color display effects, the illumination system may use light sources of different colors, a monochromatic light source with wavelength conversion components, or a combination of the above methods.

Generally, in an illumination system in which light sources of multiple colors are combined with a wavelength conversion element, the number of light sources corresponding to the light beam used to excite the wavelength conversion element is usually different from the number of light sources of other colors. Therefore, the utilization efficiency of the light spread of an existing illumination system is reduced due to a mismatch in the aspect ratios of the color light area generated by the light source used to excite the wavelength conversion element and the color light area generated by other color light sources, resulting in reduced light utilization efficiency.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system and a projection apparatus in which the aspect ratios of the color light areas of different colors are more similar. As a result, the brightness and uniformity of the illumination system are improved, and the utilization efficiency of the light spread for different color lights is significantly higher.

The other objectives and advantages of the disclosure may be further understood from the descriptive features disclosed in the disclosure.

In order to achieve one or a part or all of the above purposes or other purposes, an embodiment of the disclosure provides an illumination system. The illumination system includes a plurality of light sources, a first dichroic mirror, a second dichroic mirror, a first reflecting mirror and a second reflecting mirror. Each of the plurality of light sources is configured to provide a plurality of color lights. The plurality of light sources include a first light source, a second light source, a third light source and a fourth light source. The first light source and the third light source are arranged along a first direction, and each emits the plurality of color lights along a second direction. The second light source and the fourth light source are staggered from each other along the first direction, and each emits the plurality of color lights along a third direction. The first direction, the second direction and the third direction are different from each other. The first dichroic mirror is disposed on a transmission path of the plurality of color lights from each of the first light source and the second light source. The second dichroic mirror is disposed on a transmission path of the plurality of color lights from each of the third light source and the fourth light source. The first reflecting mirror is disposed on the transmission path of a portion of the plurality of color lights from the first dichroic mirror and emitted by each of the first light source and the second light source. The second reflecting mirror is disposed on the transmission path of a portion of the plurality of color lights from the second dichroic mirror and emitted by each of the third light source and the fourth light source. The first reflecting mirror and the second reflecting mirror are staggered from each other along the first direction, and each has the same height along the third direction.

In order to achieve one or a part or all of the above purposes or other purposes, an embodiment of the disclosure provides a projection apparatus. The projection apparatus includes an illumination system, a light valve and a projection lens. The illumination system is configured to provide an illumination light beam. The light valve is disposed on a transmission path of the illumination light beam and configured to convert the illumination light beam into an image light beam. The projection lens is disposed on a transmission path of the image light beam and configured to project the image light beam out of the projection apparatus. The illumination system includes a plurality of light sources, a first dichroic mirror, a second dichroic mirror, a first reflecting mirror and a second reflecting mirror. Each of the plurality of light sources is configured to provide a plurality of color lights. The plurality of light sources include a first light source, a second light source, a third light source and a fourth light source. The first light source and the third light source are arranged along a first direction, and each emits the plurality of color lights along a second direction. The second light source and the fourth light source are staggered from each other along the first direction, and each emits the plurality of color lights along a third direction. The first direction, the second direction and the third direction are different from each other. The first dichroic mirror is disposed on a transmission path of the plurality of color lights from each of the first light source and the second light source. The second dichroic mirror is disposed on a transmission path of the plurality of color lights from each of the third light source and the fourth light source. The first reflecting mirror is disposed on the transmission path of a portion of the plurality of color lights from the first dichroic mirror and emitted by each of the first light source and the second light source. The second reflecting mirror is disposed on the transmission path of a portion of the plurality of color lights from the second dichroic mirror and emitted by each of the third light source and the fourth light source. The first reflecting mirror and the second reflecting mirror are staggered from each other along the first direction, and each has the same height along the third direction.

Based on the above, in the illumination system and the projection apparatus of an embodiment of the disclosure, the first light source and the third light source are arranged along the first direction, and the second light source and the fourth light source are staggered from each other along the first direction. The light emitting directions of the first light source and the third light source are different from the light emitting directions of the second light source and the fourth light source. The first dichroic mirror and the second dichroic mirror are adapted to transmit a portion of color lights from the plurality of light sources along the second direction, and transmit another portion of color lights along the third direction. The first reflecting mirror arranged corresponding to the first dichroic mirror and the second reflecting mirror arranged corresponding to the second dichroic mirror are staggered from each other along the first direction, and are of the same height in the third direction. The another portion of color lights transmitted along the third direction is transmitted along the first direction after being reflected by the first reflecting mirror and the second reflecting mirror. Accordingly, the aspect ratio of the color light area formed by the portion of color lights from the plurality of light sources can be made closer to the aspect ratio of the color light area formed by the another portion of color lights, which helps to improve the utilization efficiency of the light spread of each color light from the plurality of light sources.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic top view of a projection apparatus according to a first embodiment of the disclosure.

FIG. 2A is a schematic side view of a partial area of the projection apparatus of FIG. 1.

FIG. 2B is an enlarged schematic diagram of a partial area of the projection apparatus of FIG. 1.

FIG. 3 is an enlarged stereoscopic view of a partial area of the projection apparatus of FIG. 1.

FIG. 4A and FIG. 4B are schematic diagrams of the arrangement of the light-emitting devices of each of the light sources of FIG. 1.

FIGS. 5A and FIG. 5B are schematic diagrams of the color light areas formed by the light source module of FIG. 1 on a first virtual plane and a second virtual plane respectively.

FIG. 6A and FIG. 6B are schematic diagrams of a wavelength conversion wheel in FIG. 1 and FIG. 2B.

FIG. 7 is a schematic diagram of the light emission timing sequence of different color lights from the light source module of FIG. 2A within one frame period.

FIG. 8 is a distribution diagram of transmittance versus wavelength of a dichroic mirror disposed on a transmission path of all the color lights and the converted light beam in FIG. 1.

FIG. 9 is a schematic top view of a projection apparatus according to a second embodiment of the disclosure.

FIG. 10A and FIG. 10B are schematic diagrams of the color light areas formed by the light source module of FIG. 9 on the first virtual plane and the second virtual plane respectively.

FIG. 11 is a schematic top view of a projection apparatus according to a third embodiment of the disclosure.

FIG. 12A and FIG. 12B are schematic diagrams of a wavelength conversion wheel in FIG. 11.

FIG. 13 is a schematic top view of a projection apparatus according to a fourth embodiment of the disclosure.

FIG. 14 is a schematic diagram of the wavelength conversion wheel in FIG. 13.

FIG. 15 is a distribution diagram of transmittance versus wavelength of a dichroic mirror disposed on a transmission path of all the color lights and the converted light beam in FIG. 13.

FIG. 16 is a schematic top view of a projection apparatus according to a fifth embodiment of the disclosure.

FIG. 17 is a distribution diagram of transmittance versus wavelength of a dichroic mirror disposed on a transmission path of all the color lights and the converted light beam in FIG. 16.

FIG. 18 is a schematic top view of a projection apparatus according to a sixth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

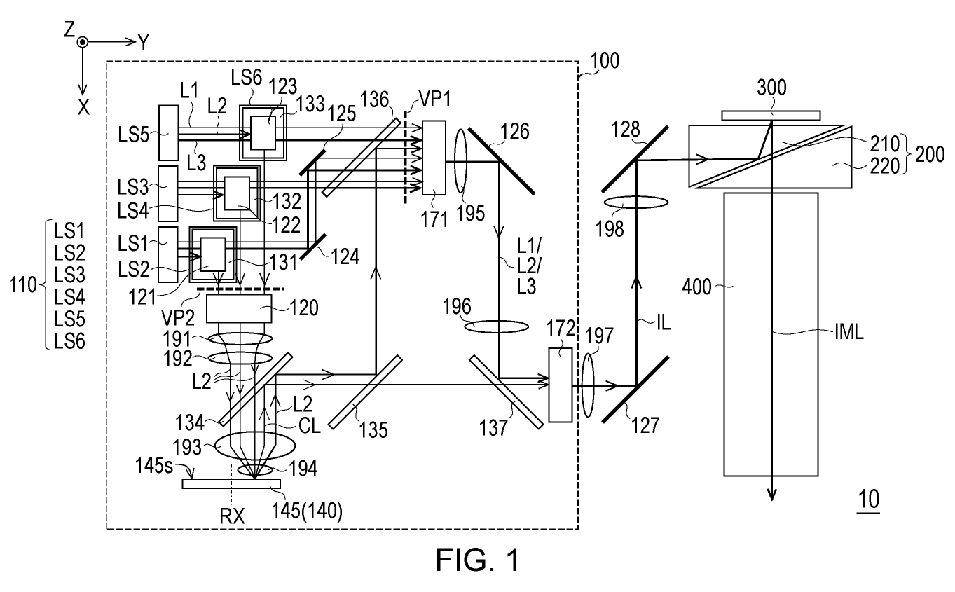

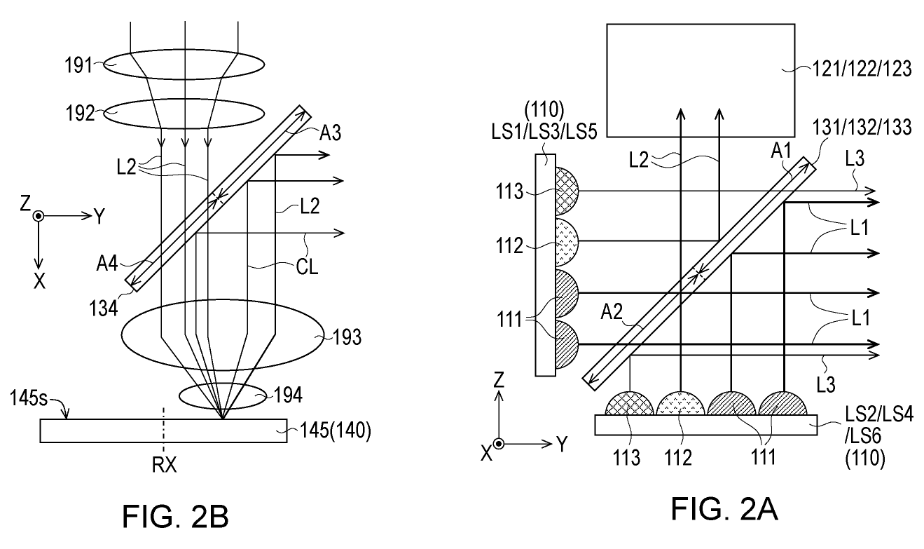

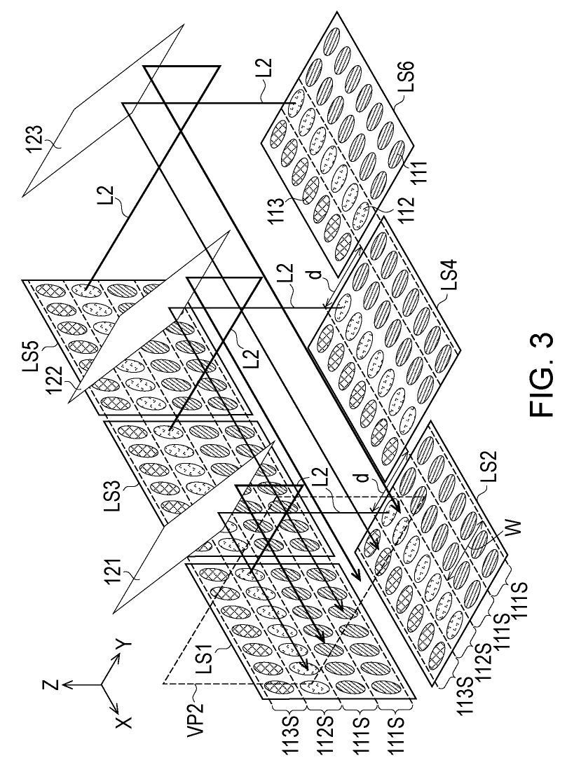

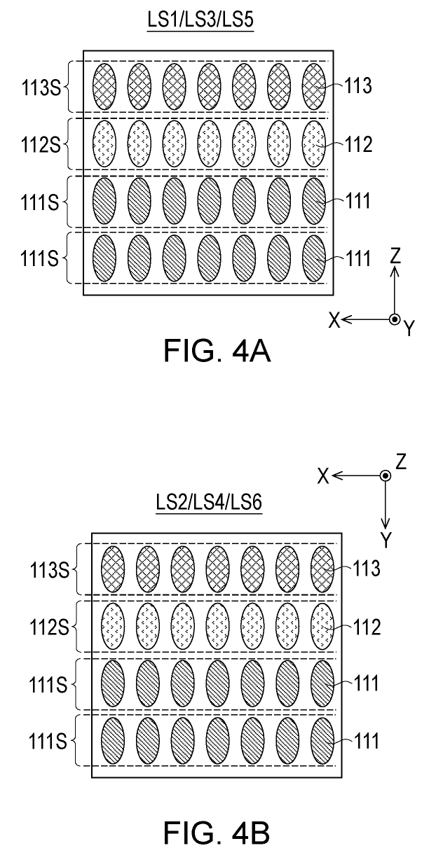

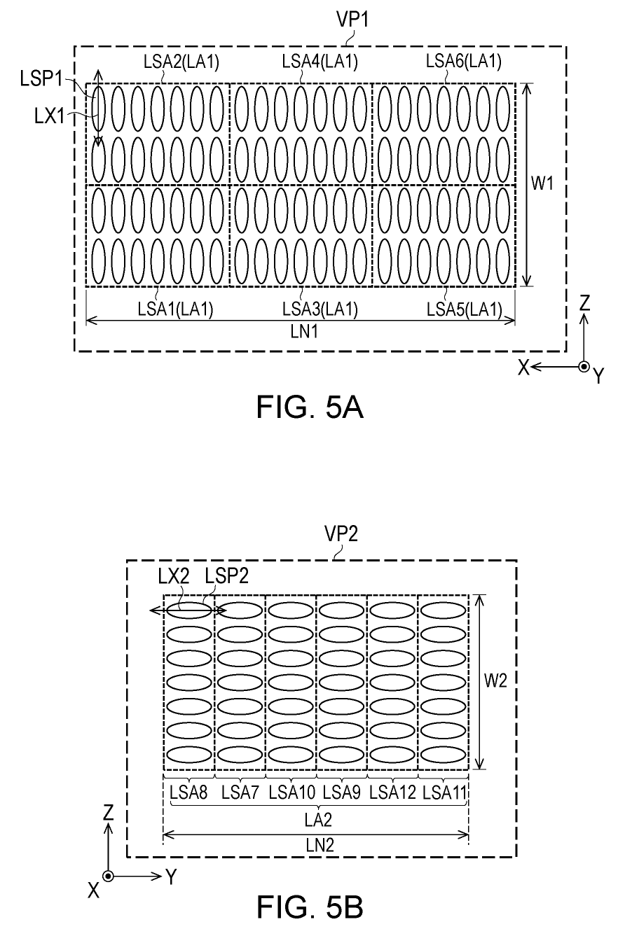

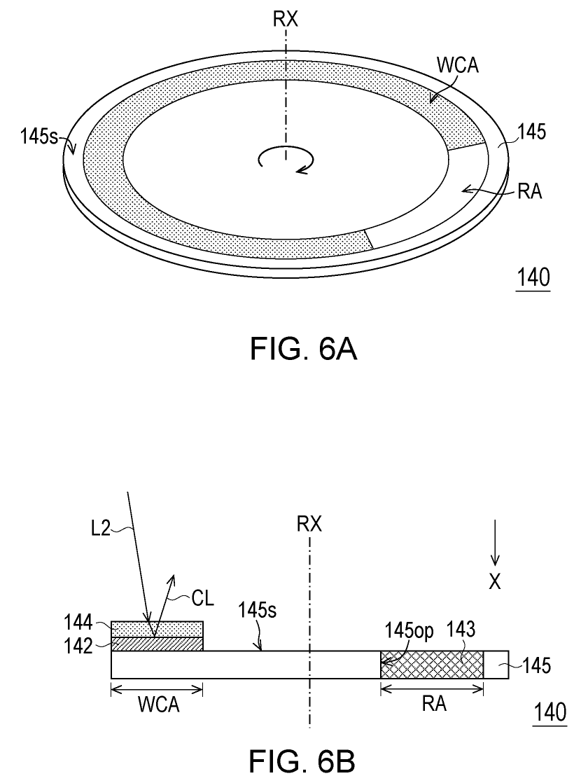

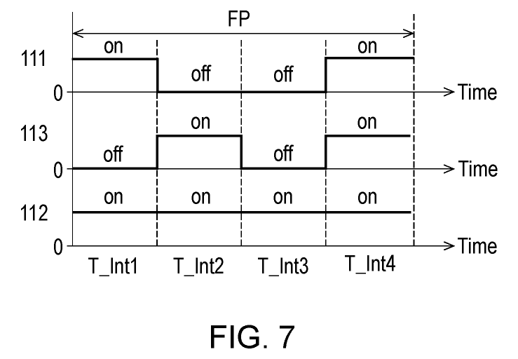

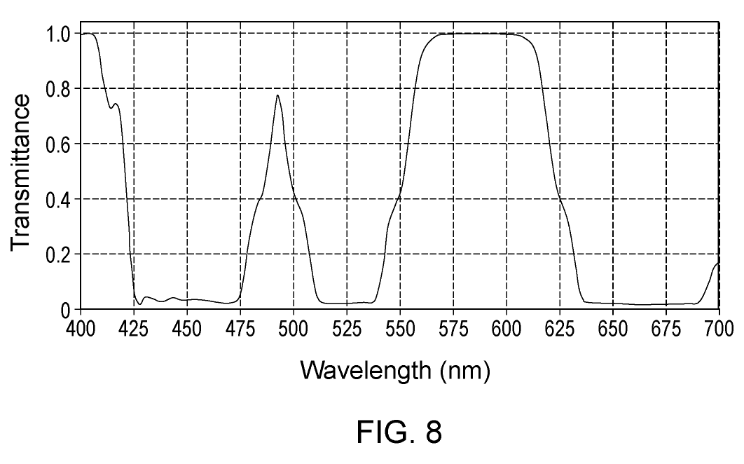

FIG. 1 is a schematic top view of a projection apparatus according to a first embodiment of the disclosure. FIG. 2A is a schematic side view of a partial area of the projection apparatus of FIG. 1. FIG. 2B is an enlarged schematic diagram of a partial area of the projection apparatus of FIG. 1. FIG. 3 is an enlarged stereoscopic view of a partial area of the projection apparatus of FIG. 1. FIG. 4A and FIG. 4B are schematic diagrams of the arrangement of the light-emitting devices of each of the light sources of FIG. 1. FIG. 5A and FIG. 5B are schematic diagrams of the color light areas formed by the light source module of FIG. 1 on a first virtual plane and a second virtual plane respectively. FIG. 6A and FIG. 6B are schematic diagrams of a wavelength conversion wheel in FIG. 1 and FIG. 2B. FIG. 7 is a schematic diagram of the light emission timing sequence of different color lights from the light source module of FIG. 2A within one frame period. FIG. 8 is a distribution diagram of transmittance versus wavelength of a dichroic mirror disposed on a transmission path of all the color lights and the converted light beam in FIG. 1. For clarity, FIG. 3 omits the illustration of the dichroic mirror 131, the dichroic mirror 132 and the dichroic mirror 133 in FIG. 2A.

Referring to FIG. 1, FIG. 2A and FIG. 3, a projection apparatus 10 (such as a projector) includes an illumination system 100. The illumination system 100 is configured to provide an illumination light beam IL and includes a light source module 110. In the embodiment, the light source module 110 may include a first light source LS1, a second light source LS2, a third light source LS3, and a fourth light source LS4, and each of the light sources is configured to provide a plurality of color lights. In some embodiments, the illumination system 100 may further include a fifth light source LS5 and a sixth light source LS6.

In the embodiment, the first light source LS1, the third light source LS3, and the fifth light source LS5 may be aligned and arranged along a direction X (first direction), and each emits the plurality of color lights along a direction Y (second direction). In other embodiments, the first light source LS1, the third light source LS3, and the fifth light source LS5 may be arranged in a staggered manner along the direction X, but maintain the same height along a direction Z (a third direction). That is, the first light source LS1, the third light source LS3 and the fifth light source LS5 are spaced apart from each other in the direction Y, and each has the same height in the direction Z. The directions X, Y and Z may intersect each other, for example, the directions X, Y and Z are perpendicular to each other.

In the embodiment, the second light source LS2, the fourth light source LS4 and the sixth light source LS6 may be arranged in a staggered manner along the direction X, and each emits the plurality of color lights along the direction Z. The second light source LS2, the fourth light source LS4 and the sixth light source LS6 are offset from each other (with an offset distance) along the direction Y, and each has the same height in the direction Z (as shown in FIG. 3). In an embodiment, the second light source LS2, the fourth light source LS4, and the sixth light source LS6, in addition to being offset from each other along the direction Y, may also be spaced apart from each other with a spacing distance along the direction Z.

For example, each light source of the light source module 110 may be configured to provide a first color light L1 and a second color light L2 of different colors. In some embodiments, the light source is also configured to provide a third color light L3. Each of the plurality of light sources includes a plurality of first light-emitting devices 111 configured to provide the first color light L1, a plurality of second light-emitting devices 112 configured to provide the second color light L2, and a plurality of third light-emitting devices 113 configured to provide the third color light L3. In the embodiment, each of the first light-emitting devices 111, the second light-emitting device 112 and the third light-emitting device 113 is, for example, a laser diode (LD) or a light emitting diode (LED).

Referring to FIG. 3, FIG. 4A and FIG. 4B, in the embodiment, the number of the first light-emitting devices 111 of each of the plurality of light sources may be different from the number of the second light-emitting devices 112 and the number of the third light-emitting devices 113. For example, the number of the first light-emitting devices 111 is twice the numbers of both the second light-emitting devices 112 and the number of the third light-emitting devices 113. In other embodiments, the number of light-emitting devices of different colors may be adjusted according to different application requirements or optical designs.

In each light source, the plurality of first light-emitting devices 111 may be arranged along the direction X to form two first device strings 111S having a total of 2*N of the plurality of first light-emitting devices 111, where N is a positive integer. The plurality of second light-emitting devices 112 may be arranged along the direction X to form a second device string 112S having N of the plurality of second light-emitting devices 112. The plurality of third light-emitting devices 113 may be arranged along the direction X to form a third device string 113S having N of the plurality of third light-emitting devices 113.

In the first light source LS1, the third light source LS3 and the fifth light source LS5, two first device strings 111S, one second device string 112S and one third device string 113S are arranged along the direction Z, and emit the first color light L1, the second color light L2 and the third color light L3, respectively, along the direction Y. In the second light source LS2, the fourth light source LS4 and the sixth light source LS6, one third device string 113S, one second device string 112S and two first device strings 111S are arranged along the direction Y, and emit the third color light L3, the second color light L2 and the first color light L1, respectively, along the direction Z.

Referring to FIG. 1 and FIG. 2A, in the embodiment, the illumination system 100 further includes a dichroic mirror 131 (first dichroic mirror), a dichroic mirror 132 (second dichroic mirror) and a dichroic mirror 133. One dichroic mirror corresponds to two light sources. For example, the dichroic mirror 131 is disposed on a transmission path of the plurality of color lights from each of the first light source LS1 and the second light source LS2. The dichroic mirror 132 is disposed on a transmission path of the plurality of color lights from each of the third light source LS3 and the fourth light source LS4. The dichroic mirror 133 is disposed on a transmission path of the plurality of color lights from each of the fifth light source LS5 and the sixth light source LS6.

In the embodiment, the dichroic mirror 131, the dichroic mirror 132 and the dichroic mirror 133 each have a first area A1 and a second area A2. The first area A1 is disposed corresponding to the second light-emitting devices 112 and the third light-emitting devices 113 of the first light source LS1, the third light source LS3 or the fifth light source LS5 and the first light-emitting devices 111 of the second light source LS2, the fourth light source LS4 or the sixth light source LS6. The second area A2 is disposed corresponding to the first light-emitting devices 111 of the first light source LS1, the third light source LS3 or the fifth light source LS5 and the second light-emitting devices 112 and the third light-emitting devices 113 of the second light source LS2, the fourth light source LS4 or the sixth light source LS6.

The first area A1 is adapted to reflect the first color lights L1 and the second color lights L2, and the second area A2 is adapted to allow the first color lights L1 and the second color lights L2 to pass through. For example, in the embodiment, the first area A1 is adapted to allow the third color lights L3 from the first light source LS1, the third light source LS3 or the fifth light source LS5 to pass through and reflect the second color lights L2 from the first light source LS1, the third light source LS3 or the fifth light source LS5 and the first color lights L1 from the second light source LS2, the fourth light source LS4 or the sixth light source LS6. The second area A2 is adapted to allow the first color lights L1 from the first light source LS1, the third light source LS3 or the fifth light source LS5 and the second color lights L2 from the second light source LS2, the fourth light source LS4 or the sixth light source LS6 to pass through and reflect the third color lights L3 from the second light source LS2, the fourth light source LS4 or the sixth light source LS6.

In the embodiment, the first color light L1, the second color light L2 and the third color light L3 are, for example, red light, blue light and green light, respectively. That is, the first area A1 of each of the dichroic mirror 131, the dichroic mirror 132 and the dichroic mirror 133 is adapted to allow green light to pass through and reflect red light and blue light. The second area A2 of each of the dichroic mirror 131, the dichroic mirror 132 and the dichroic mirror 133 is adapted to allow red light and blue light to pass through and reflect green light.

Since the second light source LS2, the fourth light source LS4 and the sixth light source LS6 are staggered from each other (are arranged in a staggered manner) along the direction X, the dichroic mirror 131, the dichroic mirror 132 and the dichroic mirror 133 are also staggered from each other (are arranged in a staggered manner) along the direction X. Since the first light source LS1, the third light source LS3 and the fifth light source LS5 have the same height in the direction Z, the dichroic mirror 131, the dichroic mirror 132 and the dichroic mirror 133 also have the same height in the direction Z.

Referring to FIGS. 1, FIG. 2A and FIG. 3, the illumination system 100 further includes a reflecting mirror 121 (first reflecting mirror), a reflecting mirror 122 (second reflecting mirror) and a reflecting mirror 123. The reflecting mirror 121 is disposed on a transmission path of the second color lights L2 from the dichroic mirror 131 and emitted by each of the first light source LS1 and the second light source LS2. The reflecting mirror 122 is disposed on a transmission path of the second color lights L2 from the dichroic mirror 132 and emitted by each of the third light source LS3 and the fourth light source LS4. The reflecting mirror 123 is disposed on a transmission path of the second color lights L2 from the dichroic mirror 133 and emitted by each of the fifth light source LS5 and the sixth light source LS6.

Since the dichroic mirror 131, the dichroic mirror 132 and the dichroic mirror 133 are staggered from each other along the direction X, the reflecting mirror 121, the reflecting mirror 122 and the reflecting mirror 123 are also staggered from each other along the direction X. In the embodiment, the reflecting mirror 121, the reflecting mirror 122 and the reflecting mirror 123 each have the same height in the direction Z.

Referring to FIG. 1 and FIG. 5A, the plurality of first color lights L1 emitted by the first light source LS1 form a light spot area LSA1 (first light spot area) on a first virtual plane VP1 after passing through the dichroic mirror 131. The plurality of first color lights L1 emitted by the second light source LS2 form a light spot area LSA2 (second light spot area) on the first virtual plane VP1 after being reflected by the dichroic mirror 131. The plurality of first color lights L1 emitted by the third light source LS3 form a light spot area LSA3 (third light spot area) on the first virtual plane VP1 after passing through the dichroic mirror 132. The plurality of first color lights L1 emitted by the fourth light source LS4 form a light spot area LSA4 (fourth light spot area) on the first virtual plane VP1 after being reflected by the dichroic mirror 132. The plurality of first color lights L1 emitted by the fifth light source LS5 form a light spot area LSA5 on the first virtual plane VP1 after passing through the dichroic mirror 133. The plurality of first color lights L1 emitted by the sixth light source LS6 form a light spot area LSA6 on the first virtual plane VP1 after being reflected by the dichroic mirror 133.

The aforementioned first virtual plane VP1 is perpendicular to an optical path of the plurality of first color lights L1 from the dichroic mirror 131, the dichroic mirror 132 and the dichroic mirror 133. In the embodiment, the first virtual plane VP1 is, for example, perpendicular to the direction Y. The light spot area LSA1 and the light spot area LSA2 are arranged along the direction Z. The light spot area LSA3 and the light spot area LSA4 are arranged along the direction Z. The light spot area LSA5 and the light spot area LSA6 are arranged along the direction Z. The light spot areas LSA1, LSA2, LSA3, LSA4, LSA5 and LSA6 do not overlap with each other on the first virtual plane VP1 and form a first color light area LA1.

Referring to FIG. 1, FIG. 3 and FIG. 5B, the plurality of second color lights L2 emitted by the first light source LS1 form a light spot area LSA7 (fifth light spot area) on a second virtual plane VP2 after being reflected by the reflecting mirror 121. The plurality of second color lights L2 emitted by the second light source LS2 form a light spot area LSA8 (sixth light spot area) on the second virtual plane VP2 after being reflected by the reflecting mirror 121. The plurality of second color lights L2 emitted by the third light source LS3 form a light spot area LSA9 (seventh light spot area) on the second virtual plane VP2 after being reflected by the reflecting mirror 122. The plurality of second color lights L2 emitted by the fourth light source LS4 form a light spot area LSA10 (eighth light spot area) on the second virtual plane VP2 after being reflected by the reflecting mirror 122. The plurality of second color lights L2 emitted by the fifth light source LS5 form a light spot area LSA11 on the second virtual plane VP2 after being reflected by the reflecting mirror 123. The plurality of second color lights L2 emitted by the sixth light source LS6 form a light spot area LSA12 on the second virtual plane VP2 after being reflected by the reflecting mirror 123.

The aforementioned second virtual plane VP2 is perpendicular to an optical path of the plurality of second color lights L2 from the reflecting mirror 121, the reflecting mirror 122 and the reflecting mirror 123. In the embodiment, the second virtual plane VP2 is, for example, perpendicular to the direction X. The light spot areas LSA7, LSA8, LSA9, LSA10, LSA11 and LSA12 are arranged along the direction Y. The light spot areas LSA7, LSA8, LSA9, LSA10, LSA11 and LSA12 do not overlap with each other on the second virtual plane VP2 and form a second color light area LA2.

In the embodiment, different from the arrangement of the plurality of light spot areas LSA1 to LSA6 along the direction X and the direction Z respectively in FIG. 5A, the plurality of light spot areas LSA7 to LSA12 formed by the plurality of second color lights L2 on the second virtual plane VP2 are only arranged along a single direction (e.g., direction Y). The difference in the aforementioned arrangement comes from the staggered arrangement of the second light source LS2, the fourth light source LS4 and the sixth light source LS6 along the direction X and the arrangement of the reflecting mirror 121, the reflecting mirror 122 and the reflecting mirror 123.

For example, the number of the first device strings 111S of each light source of the embodiment (two strings) is twice the number of the second device strings 112S (one string). An offset distance d of the second device string 112S of the fourth light source LS4 relative to the second device string 112S of the second light source LS2 along the direction Y is greater than or equal to a width W of the two first device strings 111S of the second light source LS2 along the direction Y. An offset distance d of the second device string 112S of the sixth light source LS6 relative to the second device string 112S of the fourth light source LS4 along the direction Y is greater than or equal to the width W of the two first device strings 111S along the direction Y (as shown in FIG. 3). Therefore, whether it is the offset distance between the dichroic mirror 131, the dichroic mirror 132 and the dichroic mirror 133 along the direction Y, or the offset distance between the reflecting mirror 121, the reflecting mirror 122 and the reflecting mirror 123 along the direction Y, the offset distance is approximately greater than or equal to the width W of the two first device strings 111S along the direction Y.

It should be understood that in another variant embodiment, if the number of the first device strings 111S (three strings) is three times the number of the second device strings 112S (one string), then the aforementioned offset distance of the second device string 112S of the fourth light source LS4 or the sixth light source LS6 along the direction Y should be greater than or equal to the width of three first device strings 111S along the direction Y, and so on.

Referring to FIGS. 4A to 5B, from another perspective, a major axis LX1 of a first color light spot LSP1 of each first light-emitting device 111 of each light source formed on the first virtual plane VP1 is parallel to the direction Z (as shown in FIG. 5A), and a major axis LX2 of a second color light spot LSP2 of each second light-emitting device 112 of each light source formed on the second virtual plane VP2 is parallel to the direction Y (as shown in FIG. 5B).

Referring to FIGS. 1, FIG. 5A and FIG. 5B, the first color light area LA1 respectively has a first length LN1 and a first width W1 along the direction X and the direction Z, and a ratio of the first length LN1 to the first width W1 may be defined as a first aspect ratio of the first color light area LA1. The second color light area LA2 respectively has a second length LN2 and a second width W2 along the direction Y and the direction Z, and a ratio of the second length LN2 to the second width W2 may be defined as a second aspect ratio of the second color light area LA2.

In each light source of the embodiment, the plurality of first light-emitting devices 111 are arranged into two first device strings 111S, and the plurality of second light-emitting devices 112 are arranged into one second device string 112S (as shown in FIG. 4A and FIG. 4B), that is, the number of the first light-emitting devices 111 is twice the number of the second light-emitting devices 112. In existing illumination systems, such a difference in quantity causes the first aspect ratio of the first color light area formed by the plurality of first light-emitting devices 111 to differ too much from the second aspect ratio of the second color light area formed by the plurality of second light-emitting devices 112, resulting in a reduction in the utilization efficiency of the light spread of the second color light area.

However, in the embodiment, by arranging the second light source LS2, the fourth light source LS4 and the sixth light source LS6 in a staggered manner along the direction X, along with the arrangement of the reflecting mirror 121, the reflecting mirror 122 and the reflecting mirror 123, the second aspect ratio of the second color light area LA2 formed by the plurality of second color lights L2 emitted from the first light source LS1 to the sixth light source LS6 is significantly closer to the first aspect ratio of the first color light area LA1 formed by the plurality of first color lights emitted from the first light source LS1 to the sixth light source LS6. For example, a ratio of the first aspect ratio of the first color light area LA1 to the second aspect ratio of the second color light area LA2 may be greater than or equal to 1 and less than 2. Therefore, the utilization efficiency of the light spread of the plurality of second color lights L2 emitted from the light sources may be effectively improved.

Referring to FIG. 1 and FIG. 2B, the illumination system 100 further includes a dichroic mirror 134 (third dichroic mirror) and a wavelength conversion wheel 140. The dichroic mirror 134 is disposed on a transmission path of the plurality of second color lights L2 from the reflecting mirror 121, the reflecting mirror 122 and the reflecting mirror 123 and emitted from each light source. The wavelength conversion wheel 140 is disposed on a transmission path of the plurality of second color lights L2 from the dichroic mirror 134. Referring to FIG. 2B, FIG. 6A and FIG. 6B, the wavelength conversion wheel 140 includes a substrate 145. The substrate 145 is provided with a wavelength conversion area WCA and a reflection area RA (i.e., a non-wavelength conversion area). The wavelength conversion area WCA is provided on a surface 145s of the substrate 145. A motor (not shown) of the wavelength conversion wheel 140 drives the substrate 145, thereby rotating the wavelength conversion area WCA and the reflection area RA around a rotation axis RX, so that the wavelength conversion area WCA converts the second color light L2 into a converted light beam CL and reflects the converted light beam CL to the dichroic mirror 134 within one time interval (first time interval), and the reflection area RA reflects the second color light L2 to the dichroic mirror 134 within another time interval (second time interval). That is, the wavelength conversion area WCA and the reflection area RA of the wavelength conversion wheel 140 sequentially enter the transmission path of the plurality of second color lights L2. In the embodiment, the converted light beam CL is, for example, yellow light.

The dichroic mirror 134 has a third area A3 and a fourth area A4. The third area A3 is configured to reflect the plurality of second color lights L2 and the plurality of converted light beams CL from the wavelength conversion wheel 140. In an embodiment, the third area A3 may be a reflection area. The fourth area A4 is configured to reflect the plurality of converted light beams CL from the wavelength conversion wheel 140 and allow the plurality of second color lights L2 from the reflecting mirror 121, the reflecting mirror 122 and the reflecting mirror 123 to pass through.

In the embodiment, the wavelength conversion wheel 140 may further include a reflection layer 142 and a wavelength conversion layer 144 sequentially stacked in sequence on the surface 145s. The wavelength conversion layer 144 corresponds to the wavelength conversion area WCA, and is configured to convert the second color light L2 into the converted light beam CL. The reflection layer 142 is, for example, a white diffuse reflection layer, configured to diffusely reflect the converted light beam CL to the dichroic mirror 134. The surface 145s is the incident surface of the substrate 145 facing the second color light L2. The substrate 145 of the embodiment may have an opening 145op, and a specular reflection member 143 (e.g., a reflecting mirror) is provided in the opening 145op of the substrate 145. The specular reflection member 143 corresponds to the reflection area RA. The specular reflection member 143 is configured to reflect the second color light L2 to the dichroic mirror 134. The wavelength conversion layer 144 is excited by the second color light L2 to generate the converted light beam CL. The converted light beam CL may be reflected by the reflection layer 142 and transmitted back through the wavelength conversion layer 144 to the dichroic mirror 134.

Since the second aspect ratio (i.e., the ratio of the second length LN2 to the second width W2) of the second color light area LA2 (as shown in FIG. 5B) formed by the plurality of light sources of the embodiment is close to the first aspect ratio (i.e., the ratio of the first length LN1 to the first width W1) of the first color light area LA1 (as shown in FIG. 5A), the utilization efficiency of the light spread of the second color light L2 may be effectively increased (i.e., the second color light area LA2 of the second color lights L2 is effectively enlarged compared with that of the prior art), thereby improving the excitation efficiency of the wavelength conversion layer 144.

Referring to FIGS. 1, FIG. 2A and FIG. 7, within one frame period FP of the projection apparatus 10, the light output of the light source module 110 of the illumination system 100 may be divided into four time intervals. For example, the first light-emitting device 111 is enabled to emit the first color light L1 (e.g., red light) during the time interval T_Int1 and the time interval T_Int4, and is disabled during other time intervals. The second light-emitting device 112 is enabled to emit the second color light L2 (e.g., blue light) during the four time intervals T_Int1 to T_Int4. The third light-emitting device 113 is enabled to emit the third color light L3 (e.g., green light) during the time interval T_Int2 and the time interval T_Int4, and is disabled during other time intervals. In the four time intervals T_Int1 to T_Int4, the illumination light beam IL includes at least one of red light, green light, blue light and yellow light.

From another point of view, during the time interval T_Int1, the light source module 110 emits the first color light L1 and also emits the second color light L2 to the wavelength conversion area WCA (as shown in FIG. 6B) of the wavelength conversion wheel 140 to excite the converted light beam CL (e.g., yellow light). During the time interval T_Int2, the light source module 110 emits the third color light L3 and also emits the second color light L2 to the wavelength conversion area WCA of the wavelength conversion wheel 140 to excite the converted light beam CL. During the time interval T_Int3, the light source module 110 only emits the second color light L2, wherein the second color light L2 is incident on the reflection area RA of the wavelength conversion wheel 140 via the dichroic mirror 134. During the time interval T_Int4, the light source module 110 simultaneously emits the first color light L1, the second color light L2, and the third color light L3, wherein the second color light L2 is incident on the wavelength conversion area WCA of the wavelength conversion wheel 140 via the dichroic mirror 134 to excite the converted light beam CL.

In other words, the illumination system 100 simultaneously emits the first color light L1 and the converted light beam CL during the time interval T_Int1. The illumination system 100 simultaneously emits the third color light L3 and the converted light beam CL during the time interval T_Int2. The illumination system 100 emits the second color light L2 during the time interval T_Int3. The illumination system 100 simultaneously emits the first color light L1, the third color light L3 and the converted light beam CL during the time interval T_Int4. During the time interval T_Int1, the time interval T_Int2 and the time interval T_Int4, the converted light beam CL may serve as a supplementary color light for the first color light L1 and the third color light L3 to improve the color saturation of the projected image.

In other embodiments, the first light-emitting device 111 and the third light-emitting device 113 may be enabled to simultaneously emit the first color light L1 and the third color light L3 during the time interval T_Int1, the time interval T_Int2 and the time interval T_Int4, and may be disabled only during the time interval T_Int3.

Referring to FIG. 1, in the embodiment, the illumination system 100 further includes a dichroic mirror 135 (fourth dichroic mirror), a dichroic mirror 136 (fifth dichroic mirror), a dichroic mirror 137 (sixth dichroic mirror) and a reflecting mirror 126. The dichroic mirror 135 is disposed on a transmission path of the plurality of second color lights L2 and the plurality of converted light beams CL from the dichroic mirror 134, and is configured to allow the plurality of converted light beams CL to pass through and reflect the plurality of second color lights L2. The dichroic mirror 136 is disposed on a transmission path of the plurality of first color lights L1 and the plurality of third color lights L3 from the dichroic mirror 131, the dichroic mirror 132 and the dichroic mirror 133 and the plurality of second color lights L2 from the dichroic mirror 135, and is configured to reflect the plurality of second color lights L2 and allow the plurality of first color lights L1 and the plurality of third color lights L3 to pass through.

The dichroic mirror 137 is disposed on a transmission path of the plurality of first color lights L1, the plurality of second color lights L2 and the plurality of third color lights L3 from the dichroic mirror 136 and the plurality of converted light beams CL from the dichroic mirror 135, and is configured to reflect the plurality of first color lights L1, the plurality of second color lights L2 and the plurality of third color lights L3 and allow the plurality of converted light beams CL to pass through. The reflecting mirror 126 is configured to reflect the plurality of first color lights L1, the plurality of second color lights L2 and the plurality of third color lights L3 from the dichroic mirror 136 to the dichroic mirror 137. Referring to FIG. 8, in the embodiment, the dichroic mirror 137 has a transmittance less than 0.1 for light beams with wavelength ranges between 425 nm and 475 nm, 510 nm and 530 nm, and 630 nm and 680 nm, and has a transmittance close to 1 for light beams with a wavelength range between 550 nm and 620 nm. That is, the dichroic mirror 137 is adapted to allow yellow light (i.e., the converted light beam CL) to pass through and reflect red light (i.e., the first color light L1), green light (i.e., the third color light L3) and blue light (i.e., the second color light L2).

Referring to FIG. 1, the illumination system 100 may further include a first light-homogenizing element 171 and a second light-homogenizing element 172. The light-homogenizing element 171 is disposed on the transmission path of the first color light L1, the second color light L2 and the third color light L3 from the dichroic mirror 136, and is located between the dichroic mirror 136 and the reflecting mirror 126. The second light-homogenizing element 172 is disposed on the transmission path of the first color light L1, the second color light L2, the third color light L3 and the converted light beam CL from the dichroic mirror 137. The first color light L1, the second color light L2, the third color light L3 and the converted light beam CL form an illumination light beam IL after passing through the second light-homogenizing element 172. The illumination light beam IL includes at least one of the first color light L1, the second color light L2, the third color light L3 and the converted light beam CL. Each of the first light-homogenizing element 171 and the second light-homogenizing element 172 is, for example, a lens array, an integration rod, or other optical element with a light homogenization effect. In the embodiment, the first light-homogenizing element 171 and the second light-homogenizing element 172 are, for example, lens arrays, and the first light-homogenizing element 171 is configured to solve the problem of laser speckle. The second light-homogenizing element 172 is configured to adjust the light shapes of the first color light L1, the second color light L2, the third color light L3 and the converted light beam CL to match the shape of the light incident surface of the light valve 300 (e.g., rectangular).

In the embodiment, a plurality of lenses may be provided on the optical path of the illumination system 100. For example, a lens 191 and a lens 192 may be provided on the transmission path of the second color light L2 between the light source module 110 and the dichroic mirror 134. A lens 193 and a lens 194 may be provided on the transmission path of the second color light L2 between the dichroic mirror 134 and the wavelength conversion wheel 140. A lens 195 may be provided on the transmission path of the first color light L1, the second color light L2 and the third color light L3 between the first light-homogenizing element 171 and the reflecting mirror 126. A lens 196 may be provided on the transmission path of the first color light L1, the second color light L2 and the third color light L3 between the reflecting mirror 126 and the dichroic mirror 137.

On the other hand, a guiding mirror 120 may be provided on the transmission path of the second color light L2 between the dichroic mirror 134 and each of the plurality of reflecting mirrors 121 to 123. Since the heights of the plurality of reflecting mirrors 121 to 123 in the direction Z are greater than the height of the dichroic mirror 134 in the direction Z, the second color light L2 may be transmitted between optical elements at different heights via the guiding mirror 120. The guiding mirror 120 may be, for example, composed of two reflecting mirrors, wherein the first reflecting mirror is located on the transmission path of the plurality of second color lights L2 from the plurality of reflecting mirrors 121 to 123, and the second reflecting mirror is located on the transmission path of the plurality of second color lights L2 from the above-mentioned first reflecting mirror, and the above-mentioned second reflecting mirror is configured to guide (reflect) the plurality of second color lights L2 toward the dichroic mirror 134. In the embodiment, a reflecting mirror 124 and a reflecting mirror 125 may be provided in sequence along the transmission direction and on the transmission path of the plurality of first color lights L1 and the plurality of third color lights L3 from the first light source LS1 and the second light source LS2 between the dichroic mirror 131 and the dichroic mirror 136, so that the light spot density of the first color light area LA1 of the first color light L1 formed on the first virtual plane VP1 is high.

The aforementioned first virtual plane VP1 is located on the transmission path of the first color light L1, the second color light L2 and the third color light L3 between the dichroic mirror 136 (or the plurality of dichroic mirrors 131 to 133) and the first light-homogenizing element 171, and the aforementioned second virtual plane VP2 is provided on the transmission path of the second color light L2 between the guiding mirror 120 (or the wavelength conversion wheel 140) and each of the plurality of reflecting mirrors 121 to 123.

The projection apparatus 10 may further include a prism group 200, a light valve 300 and a projection lens 400. The prism group 200 is disposed on the transmission path of the illumination light beam IL from the illumination system 100, and is configured to transmit the illumination light beam IL to the light valve 300. In the embodiment, the prism group 200 may be a total internal reflection prism group (TIR prism group) formed by two prisms 210 and 220.

The light valve 300 is disposed on the transmission path of the illumination light beam IL, and is configured to convert the illumination light beam IL into an image light beam IML. The light valve 300 is, for example, a reflective light modulator such as a liquid crystal on silicon panel (LCoS panel), a digital micromirror device (DMD), etc. Regarding the method by which the light valve 300 converts the illumination light beam IL from the illumination system 100 into the image light beam IML, sufficient instructions, recommendations, and implementation explanations for its detailed steps and implementation methods may be obtained from common knowledge in the relevant technical field. Thus, it is not further elaborated herein.

The projection lens 400 is disposed on the transmission path of the image light beam IML, and is configured to project the image light beam IML out of the projection apparatus 10 onto a projection target (not shown), such as a screen or a wall. The projection lens 400 includes, for example, a combination of one or more optical lenses with diopter, such as various combinations of non-planar lenses such as biconcave lenses, biconvex lenses, meniscus lenses, convex-concave lenses, plano-convex lenses, and plano-concave lenses. In one embodiment, the projection lens 400 may further include an optical reflecting mirror to project the image light beam IML from the light valve 300 to the projection target by reflection. The disclosure does not limit the form and type of the projection lens 400.

For example, in the embodiment, a lens 197, a reflecting mirror 127, a lens 198 and a reflecting mirror 128 may be sequentially provided along the transmission direction and on the transmission path of the illumination light beam IL between the illumination system 100 and the prism group 200.

Provided below are some other embodiments for illustrating the disclosure in detail, in which the same components will be denoted by the same reference numerals, and the description of the same technical content will be omitted. Please refer to the aforementioned embodiments for the omitted content, which will not be repeated below.

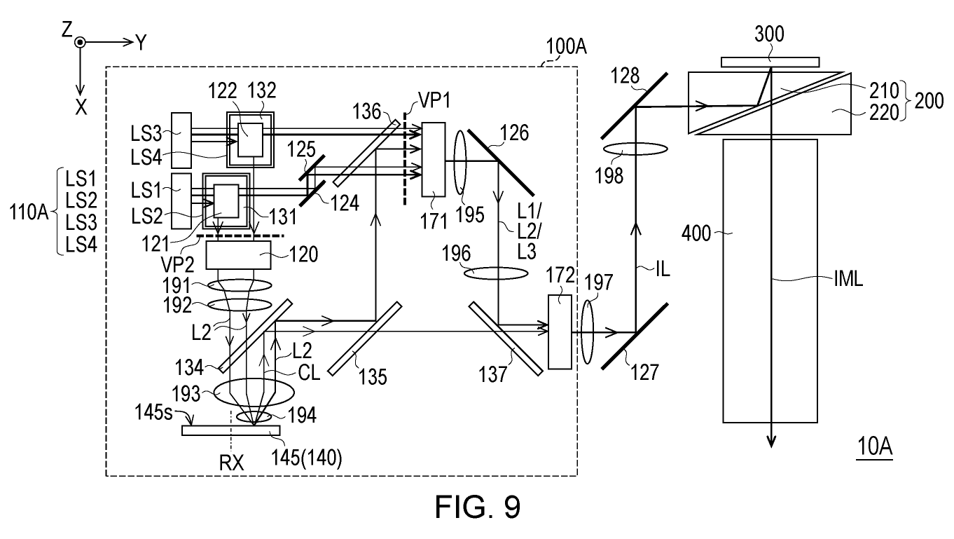

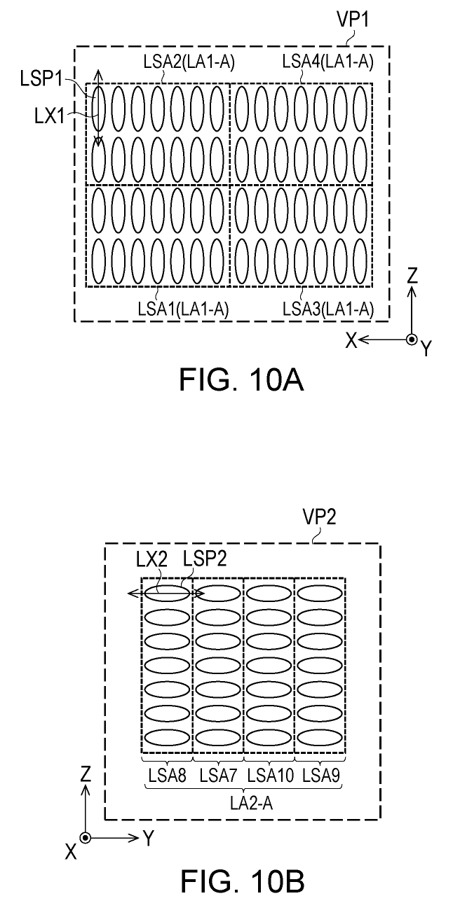

FIG. 9 is a schematic top view of a projection apparatus according to a second embodiment of the disclosure. FIG. 10A and FIG. 10B are schematic diagrams of the color light areas formed by the light source module of FIG. 9 on the first virtual plane and the second virtual plane respectively. Referring to FIG. 9, the only difference between a projection apparatus 10A of the embodiment and the projection apparatus 10 of FIG. 1 lies in the number of light sources. For example, in the projection apparatus 10A of the embodiment, the number of light sources of the light source module 110A of the illumination system 100A is four, that is, the fifth light source LS5 and the sixth light source LS6 in FIG. 1 are not provided. In some embodiments, each of the first light source LS1, the second light source LS2, the third light source LS3 and the fourth light source LS4 may include only the plurality of first light-emitting devices 111 configured to provide the first color lights L1 and the plurality of second light-emitting devices 112 configured to provide the second color lights L2.

Referring to FIG. 9, FIG. 10A and FIG. 10B, since the configuration relationship of the first light source LS1, the second light source LS2, the third light source LS3, the fourth light source LS4, the dichroic mirror 131, the dichroic mirror 132, the reflecting mirror 121 and the reflecting mirror 122 is similar to the illumination system 100 of FIG. 1, the second aspect ratio of the second color light area LA2-A, formed on the second virtual plane VP2, of the plurality of second color lights L2 emitted by each light source is also closer to the first aspect ratio of the first color light area LA1-A, formed on the first virtual plane VP1, of the plurality of first color lights L1 emitted by each light source. Therefore, the utilization efficiency of the light spread of the plurality of second color lights L2 emitted by the light sources may be effectively improved.

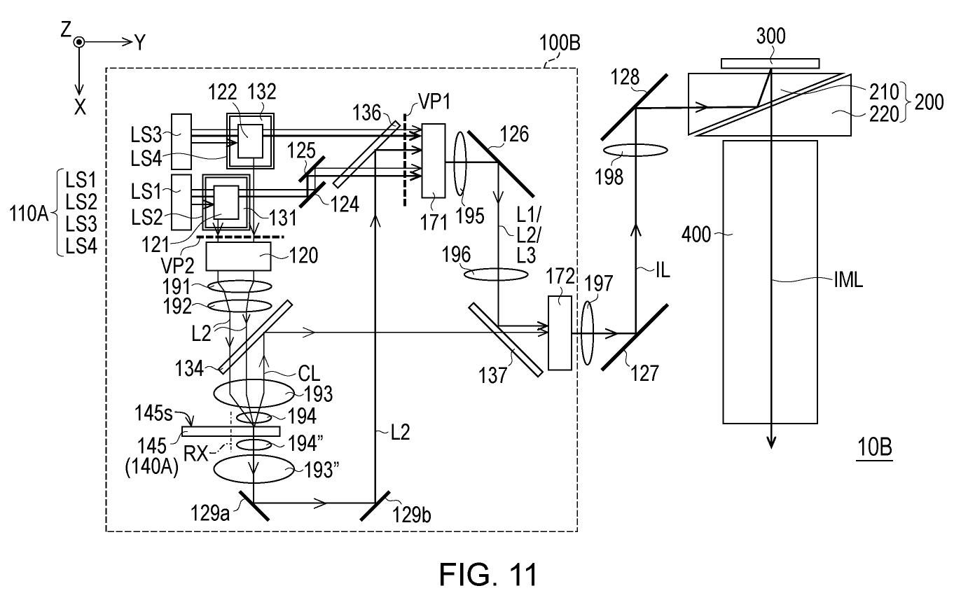

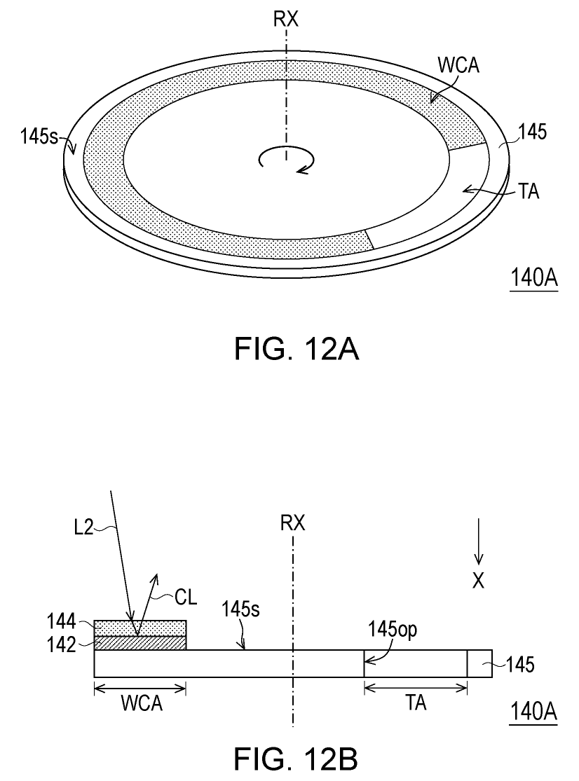

FIG. 11 is a schematic top view of a projection apparatus according to a third embodiment of the disclosure. FIG. 12A and FIG. 12Bschematic diagrams of a wavelength conversion wheel in FIG. 11. Referring to FIGS. 11 to 12B, the difference between a projection apparatus 10B of the embodiment and the projection apparatus 10A of FIG. 9 lies in the configuration of the wavelength conversion wheel.

In the illumination system 100B of the embodiment, the non-wavelength conversion area of the wavelength conversion wheel 140A is a transmission area TA. Therefore, in the embodiment, a motor (not shown) of the wavelength conversion wheel 140A drives the substrate 145, thereby rotating the wavelength conversion area WCA and the transmission area TA around a rotation axis RX, so that the wavelength conversion area WCA converts the second color light L2 into a converted light beam CL and reflects the converted light beam CL to the dichroic mirror 134 within one time interval (first time interval), and the transmission area TA allows the second color light L2 to pass through and be transmitted to the dichroic mirror 136 (fourth dichroic mirror) within another time interval (second time interval).

In the embodiment, a lens 194”, a lens 193”, a reflecting mirror 129a (third reflecting mirror) and a reflecting mirror 129b (fourth reflecting mirror) may be provided in sequence along the transmission direction and on the transmission path of the second color light L2 between the wavelength conversion wheel 140A and the dichroic mirror 136. The dichroic mirror 136 is disposed on the transmission paths of the plurality of first color lights L1 from the dichroic mirror 131 and the dichroic mirror 132 and emitted by each of the plurality of light sources and the plurality of second color lights L2 from the reflecting mirror 129a and the reflecting mirror 129b, and is configured to reflect the plurality of second color lights L2 and allow the plurality of first color lights L1 to pass through. The dichroic mirror 137 (fifth dichroic mirror) is disposed on the transmission path of the plurality of converted light beams CL from the dichroic mirror 134 and the plurality of first color lights L1 and the plurality of second color lights L2 from the dichroic mirror 136. The dichroic mirror 137 is configured to reflect the plurality of first color lights L1 and the plurality of second color lights L2, and allow the converted light beams CL to pass through. In the embodiment, the second color light L2, after incident on the wavelength conversion wheel 140A, is not reflected back to the dichroic mirror 134 as shown for the second color light L2 in FIG. 1, so the dichroic mirror 134 of the embodiment may be formed without a separate region. That is, the dichroic mirror 134 of the embodiment may have the same spectral characteristics, i.e., the characteristics suitable for allowing the second color light L2 to pass through and reflecting the converted light beam CL, in the third area A3 and the fourth area A4 shown in FIG. 2B.

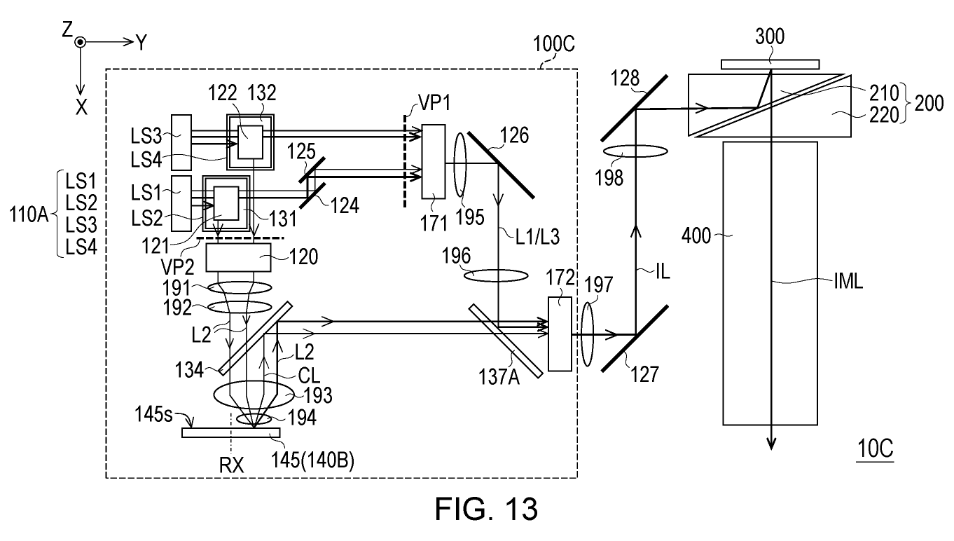

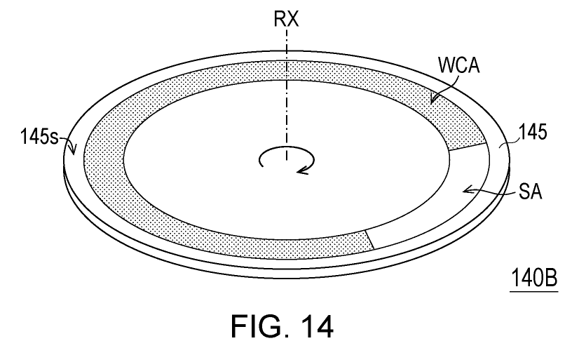

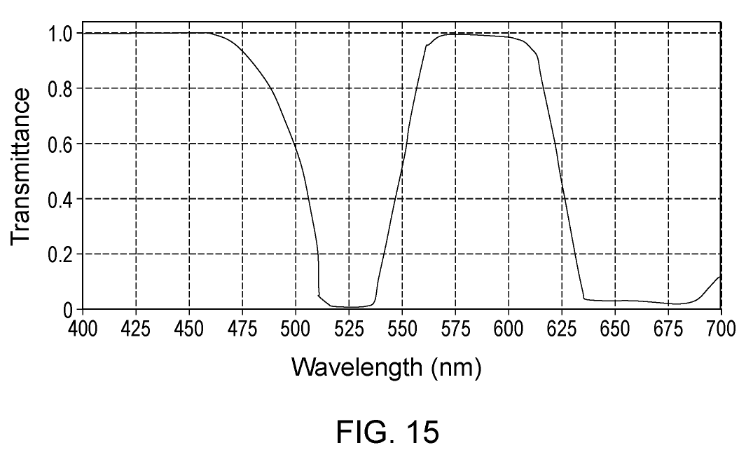

FIG. 13 is a schematic top view of a projection apparatus according to a fourth embodiment of the disclosure. FIG. 14 is a schematic diagram of the wavelength conversion wheel in FIG. 13. FIG. 15 is a distribution diagram of transmittance versus wavelength of a dichroic mirror disposed on a transmission path of all the color lights and the converted light beam in FIG. 13. Referring to FIGS. 13 and 14, the difference between a projection apparatus 10C of the embodiment and the projection apparatus 10A of FIG. 9 lies in the configuration of the wavelength conversion wheel.

In the illumination system 100C of the embodiment, the non-wavelength conversion area of the wavelength conversion wheel 140B is a scattering area SA. Therefore, in the embodiment, a motor (not shown) of the wavelength conversion wheel 140B drives the substrate 145, thereby rotating the wavelength conversion area WCA and the scattering area SA around a rotation axis RX, so that the wavelength conversion area WCA converts the second color light L2 into a converted light beam CL and reflects the converted light beam CL to the dichroic mirror 134 within one time interval (first time interval), and the scattering area SA diffusely reflects the plurality of second color lights L2 to the dichroic mirror 134 within another time interval (second time interval).

Since the wavelength conversion wheel 140B of the embodiment is provided with the scattering area SA, the plurality of second color lights L2 have a certain degree of light spreading effect after being diffusely reflected by the scattering area SA. Therefore, the plurality of second color lights L2 leaving the wavelength conversion wheel 140B may be directly transmitted to the second light-homogenizing element 172. In other words, the illumination system 100C of the embodiment may omit the dichroic mirror 135 in FIG. 9, and the spectral characteristics of the dichroic mirror 137A are also different from that of the dichroic mirror 137 in FIG. 9. For example, the dichroic mirror 137A of the embodiment is adapted to allow the second color light L2 (e.g., blue light) and the converted light beam CL (e.g., yellow light) from the dichroic mirror 134 to pass through and reflect the first color light L1 (e.g., red light) and the third color light L3 (e.g., green light) from the first light-homogenizing element 171, as shown in FIG. 15.

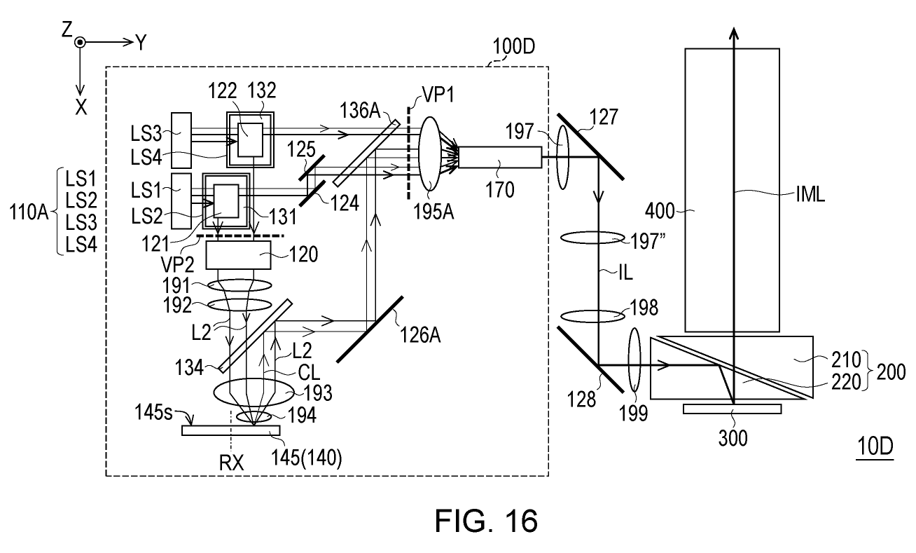

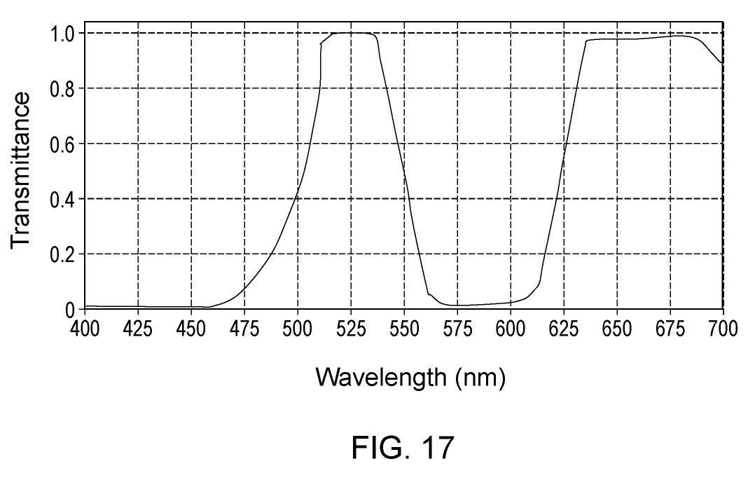

FIG. 16 is a schematic top view of a projection apparatus according to a fifth embodiment of the disclosure. FIG. 17 is a distribution diagram of transmittance versus wavelength of a dichroic mirror disposed on a transmission path of all the color lights and the converted light beam in FIG. 16. Referring to FIG. 16, the difference between a projection apparatus 10D of the embodiment and the projection apparatus 10A of FIG. 9 lies in the type of the light-homogenizing elements and the optical path of the converted light beam(s).

In the illumination system 100D of the embodiment, the light-homogenizing element 170 is, for example, an integration rod. In other modified embodiments, the light-homogenizing element 170 may be a lens array or other optical element with a light homogenization effect. A reflecting mirror 126A (third reflecting mirror) may be provided on the transmission path of the converted light beam CL and the second color light L2 from the wavelength conversion wheel 140. The reflecting mirror 126A is configured to reflect the converted light beam CL and the second color light L2 to the dichroic mirror 136A (fourth dichroic mirror). Therefore, in the embodiment, the dichroic mirror 136A is adapted to allow the plurality of first color lights L1 (e.g., red light) and the plurality of third color lights L3 (e.g., green light) from the plurality of light sources to pass through, and reflect the plurality of second color lights L2 (e.g., blue light) and the converted light beam(s) CL (e.g., yellow light) from the wavelength conversion wheel 140, as shown in FIG. 17.

In the embodiment, a lens 195A may be provided on the transmission path of the first color light L1, the second color light L2, the third color light L3 and the converted light beam CL between the dichroic mirror 136A and the light-homogenizing element 170, and a lens 197” may be provided on the transmission path of the illumination light beam IL between the reflecting mirror 127 and the reflecting mirror 128.

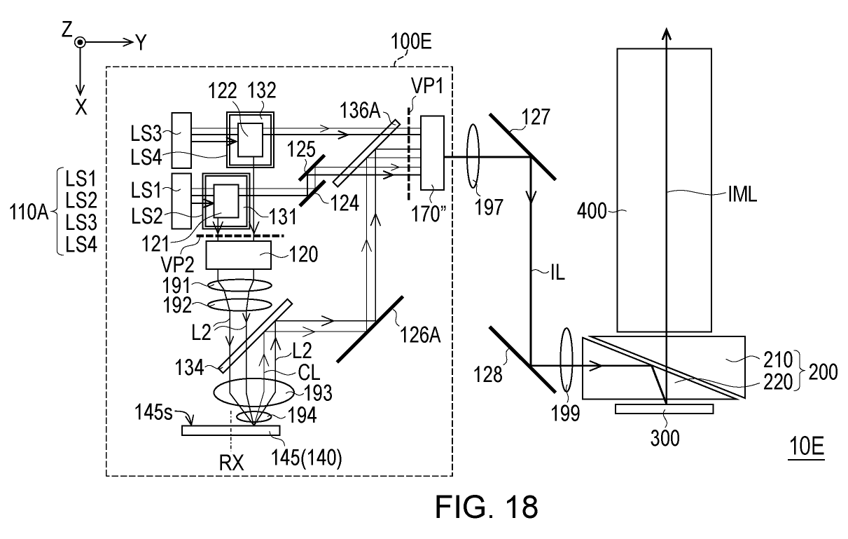

FIG. 18 is a schematic top view of a projection apparatus according to a sixth embodiment of the disclosure. Referring to FIG. 18, the main difference between a projection apparatus 10E of the embodiment and the projection apparatus 10D of FIG. 16 lies in the type of light-homogenizing elements. In the illumination system 100E of the embodiment, the light-homogenizing element 170” is, for example, a single lens. On the other hand, the projection apparatus 10E of the embodiment omits the arrangement of certain lenses in FIG. 16.

It should be noted that the light source module 110 including six light sources in FIG. 1 may also be applied to the illumination system 100A of FIG. 9, the illumination system 100B of FIG. 11, the illumination system 100C of FIG. 13, the illumination system 100D of FIG. 16 and the illumination system 100E of FIG. 18. For detailed description, please refer to the relevant paragraphs of the foregoing embodiments, which will not be described again here.

To sum up, in the illumination system and the projection apparatus of an embodiment of the disclosure, the first light source and the third light source are arranged along the first direction, and the second light source and the fourth light source are staggered from each other along the first direction. The light emitting directions of the first light source and the third light source are different from the light emitting directions of the second light source and the fourth light source. The first dichroic mirror and the second dichroic mirror are adapted to transmit a portion of color lights from the plurality of light sources along the second direction, and transmit another portion of color lights along the third direction. The first reflecting mirror arranged corresponding to the first dichroic mirror and the second reflecting mirror arranged corresponding to the second dichroic mirror are staggered from each other along the first direction, and are of the same height in the third direction. The another portion of color lights transmitted along the third direction is transmitted along the first direction after being reflected by the first reflecting mirror and the second reflecting mirror. Accordingly, the aspect ratio of the color light area formed by the portion of color lights from the plurality of light sources may be made closer to the aspect ratio of the color light area formed by the another portion of color lights, which helps to improve the utilization efficiency of the light spread of each color light from the plurality of light sources.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The use of “at least one of...and...” thereof herein may include “one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising a plurality of light sources, a first dichroic mirror, a second dichroic mirror, a first reflecting mirror and a second reflecting mirror, wherein each of the plurality of light sources is configured to provide a plurality of color lights, the plurality of light sources include a first light source, a second light source, a third light source and a fourth light source, the first light source and the third light source are arranged along a first direction, and each emits the plurality of color lights along a second direction, the second light source and the fourth light source are staggered from each other along the first direction, and each emits the plurality of color lights along a third direction, the first direction, the second direction and the third direction are different from each other,
the first dichroic mirror is disposed on a transmission path of the plurality of color lights from each of the first light source and the second light source, the second dichroic mirror is disposed on a transmission path of the plurality of color lights from each of the third light source and the fourth light source,
the first reflecting mirror is disposed on the transmission path of a portion of the plurality of color lights from the first dichroic mirror and emitted by each of the first light source and the second light source, the second reflecting mirror is disposed on the transmission path of a portion of the plurality of color lights from the second dichroic mirror and emitted by each of the third light source and the fourth light source, and
the first reflecting mirror and the second reflecting mirror are staggered from each other along the first direction, and each has the same height along the third direction.

2. The illumination system according to claim 1, wherein the plurality of color lights include a plurality of first color lights and a plurality of second color lights, the first dichroic mirror and the second dichroic mirror each have a first area and a second area, the first area is configured to reflect the plurality of first color lights and the plurality of second color lights, and the second area is configured to allow the plurality of first color lights and the plurality of second color lights to pass through.

3. The illumination system according to claim 2, wherein the first reflecting mirror is configured to reflect the plurality of second color lights emitted by each of the first light source and the second light source, and the second reflecting mirror is configured to reflect the plurality of second color lights emitted by each of the third light source and the fourth light source.

4. The illumination system according to claim 3, wherein each of the plurality of light sources includes a plurality of first light-emitting devices and a plurality of second light-emitting devices, the plurality of first light-emitting devices are configured to emit the plurality of first color lights, the plurality of second light-emitting devices are configured to emit the plurality of second color lights, the plurality of first light-emitting devices are arranged into two first device strings having a total of 2*N of the plurality of first light-emitting devices, the plurality of second light-emitting devices are arranged into a second device string having N of the plurality of second light-emitting devices, N is a positive integer,
the two first device strings and the second device string of each of the first light source and the third light source are arranged along the third direction, and the second device string and the two first device strings of each of the second light source and the fourth light source are arranged along the second direction.

5. The illumination system according to claim 4, wherein an offset distance of the second device string of the fourth light source relative to the second device string of the second light source along the second direction is greater than or equal to a width of the two first device strings of the second light source along the second direction.

6. The illumination system according to claim 4, wherein the plurality of first color lights emitted by the first light source form a first light spot area on a first virtual plane after passing through the first dichroic mirror, the plurality of first color lights emitted by the second light source form a second light spot area on the first virtual plane after being reflected by the first dichroic mirror, the plurality of first color lights emitted by the third light source form a third light spot area on the first virtual plane after passing through the second dichroic mirror, the plurality of first color lights emitted by the fourth light source form a fourth light spot area on the first virtual plane after being reflected by the second dichroic mirror, the first virtual plane is perpendicular to an optical path of the plurality of first color lights from the first dichroic mirror and the second dichroic mirror, the first light spot area, the second light spot area, the third light spot area and the fourth light spot area do not overlap with each other and form a first color light area,
the plurality of second color lights emitted by the first light source form a fifth light spot area on a second virtual plane after being reflected by the first reflecting mirror, the plurality of second color lights emitted by the second light source form a sixth light spot area on the second virtual plane after being reflected by the first reflecting mirror, the plurality of second color lights emitted by the third light source form a seventh light spot area on the second virtual plane after being reflected by the second reflecting mirror, the plurality of second color lights emitted by the fourth light source form an eighth light spot area on the second virtual plane after being reflected by the second reflecting mirror, the second virtual plane is perpendicular to an optical path of the plurality of second color lights from the first reflecting mirror and the second reflecting mirror, the fifth light spot area, the sixth light spot area, the seventh light spot area and the eighth light spot area do not overlap with each other and form a second color light area,
the first color light area respectively has a first length and a first width along the first direction and the third direction, a ratio of the first length to the first width is a first aspect ratio, the second color light area respectively has a second length and a second width along the second direction and the third direction, a ratio of the second length to the second width is a second aspect ratio, and a ratio of the first aspect ratio to the second aspect ratio is greater than or equal to 1 and less than 2.

7. The illumination system according to claim 6, wherein the first light spot area and the second light spot area are arranged along the third direction, the third light spot area and the fourth light spot area are arranged along the third direction, the first light spot area and the third light spot area are arranged along the first direction, the second light spot area and the fourth light spot area are arranged along the first direction, and the fifth light spot area, the sixth light spot area, the seventh light spot area and the eighth light spot area are arranged along the second direction.

8. The illumination system according to claim 6, further comprising a third dichroic mirror, a wavelength conversion wheel and a light-homogenizing element, the third dichroic mirror is disposed on a transmission path of the plurality of second color lights from the first reflecting mirror and the second reflecting mirror and emitted by each of the plurality of light sources, the wavelength conversion wheel is disposed on the transmission path of the plurality of second color lights from the third dichroic mirror and emitted by each of the plurality of light sources, the light-homogenizing element is disposed on a transmission path of the plurality of first color lights from the first dichroic mirror and the second dichroic mirror, wherein the first virtual plane is located between the first dichroic mirror and the light-homogenizing element, and the second virtual plane is located between the first reflecting mirror and the wavelength conversion wheel.

9. The illumination system according to claim 6, wherein a major axis of a first color light spot of each of the plurality of first light-emitting devices formed on the first virtual plane is parallel to the third direction, and a major axis of a second color light spot of each of the plurality of second light-emitting devices formed on the second virtual plane is parallel to the second direction.

10. The illumination system according to claim 3, further comprising a third dichroic mirror and a wavelength conversion wheel, the third dichroic mirror is disposed on a transmission path of the plurality of second color lights from the first reflecting mirror and the second reflecting mirror, the wavelength conversion wheel is disposed on a transmission path of the plurality of second color lights from the third dichroic mirror, the wavelength conversion wheel has a wavelength conversion area and a non-wavelength conversion area, the wavelength conversion area and the non-wavelength conversion area sequentially enter the transmission path of the plurality of second color lights, the wavelength conversion area is configured to convert the plurality of second color lights emitted by each of the plurality of light sources into a plurality of converted light beams and reflect the plurality of converted light beams to the third dichroic mirror within a first time interval, and the non-wavelength conversion area is configured to transmit the plurality of second color lights emitted by each of the plurality of light sources to at least one light-homogenizing element within a second time interval.

11. The illumination system according to claim 10, wherein the third dichroic mirror has a third area and a fourth area, the third area is configured to reflect the plurality of second color lights and the plurality of converted light beams, and the fourth area is configured to reflect the plurality of converted light beams and allow the plurality of second color lights to pass through.

12. The illumination system according to claim 10, further comprising a fourth dichroic mirror, a fifth dichroic mirror and a sixth dichroic mirror, the plurality of second color lights from the non-wavelength conversion area are transmitted to the third dichroic mirror, the fourth dichroic mirror is disposed on a transmission path of the plurality of second color lights and the plurality of converted light beams from the third dichroic mirror, the fourth dichroic mirror is configured to allow the plurality of converted light beams from the third dichroic mirror to pass through and reflect the plurality of second color lights from the third dichroic mirror,
the fifth dichroic mirror is disposed on a transmission path of the plurality of first color lights from the first dichroic mirror and the second dichroic mirror and the plurality of second color lights from the fourth dichroic mirror, the fifth dichroic mirror is configured to reflect the plurality of second color lights and allow the plurality of first color lights to pass through,
the sixth dichroic mirror is disposed on a transmission path of the plurality of first color lights and the plurality of second color lights from the fifth dichroic mirror and the plurality of converted light beams from the fourth dichroic mirror, and the sixth dichroic mirror is configured to reflect the plurality of first color lights and the plurality of second color lights and allow the plurality of converted light beams to pass through.

13. The illumination system according to claim 10, wherein the at least one light-homogenizing element includes a first light-homogenizing element and a second light-homogenizing element, the first light-homogenizing element is disposed on a transmission path of the plurality of first color lights from the first dichroic mirror and the second dichroic mirror, and the second light-homogenizing element is disposed on a transmission path of the plurality of converted light beams and the plurality of second color lights from the wavelength conversion wheel and the plurality of first color lights from the first light-homogenizing element.

14. The illumination system according to claim 13, wherein the first light-homogenizing element is also disposed on a transmission path of the plurality of second color lights from the wavelength conversion wheel, and the plurality of second color lights from the wavelength conversion wheel are first transmitted to the first light-homogenizing element and then transmitted to the second light-homogenizing element.

15. The illumination system according to claim 13, further comprising a fourth dichroic mirror, wherein the plurality of second color lights from the non-wavelength conversion area are transmitted to the third dichroic mirror, the fourth dichroic mirror is disposed on a transmission path of the plurality of second color lights and the plurality of converted light beams from the third dichroic mirror and the plurality of first color lights from the first light-homogenizing element, and the fourth dichroic mirror is configured to reflect the plurality of first color lights and allow the plurality of second color lights and the plurality of converted light beams to pass through.

16. The illumination system according to claim 10, further comprising a third reflecting mirror and a fourth dichroic mirror, wherein the plurality of second color lights from the non-wavelength conversion area are transmitted to the third dichroic mirror, the third reflecting mirror is disposed on a transmission path of the plurality of second color lights and the plurality of converted light beams from the third dichroic mirror, and is configured to reflect the plurality of second color lights and the plurality of converted light beams, the fourth dichroic mirror is disposed on a transmission path of the plurality of first color lights from the first dichroic mirror and the second dichroic mirror and the plurality of second color lights and the plurality of converted light beams from the third reflecting mirror, and the fourth dichroic mirror is configured to reflect the plurality of second color lights and the plurality of converted light beams, and allow the plurality of first color lights to pass through.

17. The illumination system according to claim 10, wherein the at least one light-homogenizing element is disposed on a transmission path of the plurality of first color lights from the first dichroic mirror and the second dichroic mirror and the plurality of second color lights and the plurality of converted light beams from the wavelength conversion wheel.

18. The illumination system according to claim 10, further comprising a third reflecting mirror, a fourth reflecting mirror, a fourth dichroic mirror and a fifth dichroic mirror, wherein the third reflecting mirror and the fourth reflecting mirror are disposed on a transmission path of the plurality of second color lights from the wavelength conversion wheel,
the fourth dichroic mirror is disposed on a transmission path of the plurality of first color lights from the first dichroic mirror and the second dichroic mirror and emitted by each of the plurality of light sources and the plurality of second color lights from the third reflecting mirror and the fourth reflecting mirror, the fourth dichroic mirror is configured to reflect the plurality of second color lights, and allow the plurality of first color lights to pass through,
the fifth dichroic mirror is disposed on a transmission path of the plurality of converted light beams from the third dichroic mirror and the plurality of first color lights and the plurality of second color lights from the fourth dichroic mirror, and the fifth dichroic mirror is configured to reflect the plurality of first color lights and the plurality of second color lights, and allow the plurality of converted light beams to pass through.

19. A projection apparatus, comprising:
an illumination system, configured to provide an illumination light beam and comprising a plurality of light sources, a first dichroic mirror, a second dichroic mirror, a first reflecting mirror and a second reflecting mirror, wherein each of the plurality of light sources is configured to provide a plurality of color lights, the plurality of light sources includes a first light source, a second light source, a third light source and a fourth light source, the first light source and the third light source are arranged along a first direction, and each emits the plurality of color lights along a second direction, the second light source and the fourth light source are staggered from each other along the first direction, and each emits the plurality of color lights along a third direction, the first direction, the second direction and the third direction are different from each other,
the first dichroic mirror is disposed on a transmission path of the plurality of color lights from each of the first light source and the second light source, the second dichroic mirror is disposed on a transmission path of the plurality of color lights from each of the third light source and the fourth light source,
the first reflecting mirror is disposed on the transmission path of a portion of the plurality of color lights from the first dichroic mirror and emitted by each of the first light source and the second light source, the second reflecting mirror is disposed on the transmission path of a portion of the plurality of color lights from the second dichroic mirror and emitted by each of the third light source and the fourth light source, and
the first reflecting mirror and the second reflecting mirror are staggered from each other along the first direction, and each has the same height along the third direction;
a light valve, disposed on a transmission path of the illumination light beam and configured to convert the illumination light beam into an image light beam; and
a projection lens, disposed on a transmission path of the image light beam and configured to project the image light beam out of the projection apparatus.

20. The projection apparatus according to claim 19, wherein the plurality of color lights include a plurality of first color lights and a plurality of second color lights, the first dichroic mirror and the second dichroic mirror each have a first area and a second area, the first area is configured to reflect the plurality of first color lights and the plurality of second color lights, and the second area is configured to allow the plurality of first color lights and the plurality of second color lights to pass through.

21. The projection apparatus according to claim 20, wherein the first reflecting mirror is configured to reflect the plurality of second color lights emitted by each of the first light source and the second light source, and the second reflecting mirror is configured to reflect the plurality of second color lights emitted by each of the third light source and the fourth light source.

22. The projection apparatus according to claim 21, wherein each of the plurality of light sources includes a plurality of first light-emitting devices and a plurality of second light-emitting devices, the plurality of first light-emitting devices are configured to emit the plurality of first color lights, the plurality of second light-emitting devices are configured to emit the plurality of second color lights, the plurality of first light-emitting devices are arranged into two first device strings having 2*N of the plurality of first light-emitting devices, the plurality of second light-emitting devices are arranged into a second device string having N of the plurality of second light-emitting devices, N is a positive integer,
the two first device strings and the second device string of each of the first light source and the third light source are arranged along the third direction, and the second device string and the two first device strings of each of the second light source and the fourth light source are arranged along the second direction.

23. The projection apparatus according to claim 22, wherein an offset distance of the second device string of the fourth light source relative to the second device string of the second light source along the second direction is greater than or equal to a width of the two first device strings of the second light source along the second direction.

24. The projection apparatus according to claim 22, wherein the plurality of first color lights emitted by the first light source form a first light spot area on a first virtual plane after passing through the first dichroic mirror, the plurality of first color lights emitted by the second light source form a second light spot area on the first virtual plane after being reflected by the first dichroic mirror, the plurality of first color lights emitted by the third light source form a third light spot area on the first virtual plane after passing through the second dichroic mirror, the plurality of first color lights emitted by the fourth light source form a fourth light spot area on the first virtual plane after being reflected by the second dichroic mirror, the first virtual plane is perpendicular to an optical path of the plurality of first color lights from the first dichroic mirror and the second dichroic mirror, the first light spot area, the second light spot area, the third light spot area and the fourth light spot area do not overlap with each other and form a first color light area,
the plurality of second color lights emitted by the first light source form a fifth light spot area on a second virtual plane after being reflected by the first reflecting mirror, the plurality of second color lights emitted by the second light source form a sixth light spot area on the second virtual plane after being reflected by the first reflecting mirror, the plurality of second color lights emitted by the third light source form a seventh light spot area on the second virtual plane after being reflected by the second reflecting mirror, the plurality of second color lights emitted by the fourth light source form an eighth light spot area on the second virtual plane after being reflected by the second reflecting mirror, the second virtual plane is perpendicular to an optical path of the plurality of second color lights from the first reflecting mirror and the second reflecting mirror, the fifth light spot area, the sixth light spot area, the seventh light spot area and the eighth light spot area do not overlap with each other and form a second color light area,
the first color light area respectively has a first length and a first width along the first direction and the third direction, a ratio of the first length to the first width is a first aspect ratio, the second color light area respectively has a second length and a second width along the second direction and the third direction, a ratio of the second length to the second width is a second aspect ratio, and a ratio of the first aspect ratio to the second aspect ratio is greater than or equal to 1 and less than 2.
